(19) United States
(12) Patent Application Publication
(10) Pub. No.: US 2013/0077112 A1
(43) Pub. Date: Mar. 28, 2013

(54) AUTOMATIC AGGREGATION OF MULTIPLE DOCUMENTS INTO A COMMON PROCESSING JOB

(71) Applicant: Christian James Dodd, Hertfordshire (GB)

(72) Inventor: Christian James Dodd, Hertfordshire (GB)

(73) Assignee: Xerox Corporation, Norwalk, CT (US)

(21) Appl. No.: 13/239,665

(22) Filed: Sep. 22, 2011

(51) Int. Cl. G06K 15/02

(52) U.S. Cl. 358/1.13; 358/1.16

(57) ABSTRACT

As set forth herein, methods and systems for automatic grouping of individual print jobs into a common job at a multifunction device. Received jobs stored in a job processing queue are analyzed to determine the filenames, submission times, and other related identification data. Those jobs sharing a common naming convention, submission time interval, or other common identifiers, are automatically grouped into a single, common job. Upon login, the user is able to approve or disapprove the grouping. For an approved grouping, the user is able to select finishing options via the user interface of the multifunction device to be applied to the common job. The common job, in which the finishing options have been propagated through each formerly individual job, is then output as if it were a single job by the multifunction device.

### TECHNICAL FIELD

The presently disclosed embodiments are directed toward methods and systems for printing, reproducing or displaying images. More particularly, the teachings disclosed herein are applicable to methods and systems wherein automatic grouping of individual documents into a single processing job are implemented.

### BACKGROUND

A multifunction device is generally capable of performing a variety of services, including printing, scanning, copying, facsimile, storage, electronic mailing, and the like. The user interfaces associated with such devices include alphanumeric keyboards, touch screen displays, color displays, biometric interfaces, and the like. One feature of such a multifunction device is the ability to allow for secure printing of jobs submitted by users. That is, when a user desires to prevent others from viewing an print job, the user may select a secure printing operation. In such an operation, the user submits a document processing job to the printer for storage in a job queue that is restricted in access to that user. The multifunction device will then store the job in the queue until released by the user, e.g., the user logs onto the multifunction device using a username/password and selects the job to be output once the user is physically present at the multifunction device. This prevents others from viewing the job either during printing, or while the job is resting in the output tray of the multifunction device.

Multiple print jobs, which are related, such as “file per page” scanned documents, are generally treated as separate and distinct document processing jobs by the multifunction device. For example, some file-types, e.g., JPEG, TIF, GIF, or the like, typically include a single page per file. Accordingly, combining such jobs at the multifunction device is not possible, resulting in users having to select finishing options, e.g., stapling, hole-punching, duplex printing, etc., for each separate job. That is, the user must manually identify such multiple jobs as related where drivers on the sending device, e.g., the personal computer or workstation, make such features available. When the above-noted secure printing features are used, a user typically is provided with the option or printing a single job, or all of the user's jobs. In either case, any jobs so selected and released are treated as separate; duplex, stapling, and other finishing options are not available.

In continuing with the secure printing operations, when a user prints multiple “file per page” type jobs, individual banner sheets are printed, resulting in substantial waste of output media and toner. Additionally, time and effort must be expended to manually sort, staple, hole-punch, or otherwise finish a job.

### INCORPORATION BY REFERENCE

The following references, the disclosures of which are incorporated herein by reference in their entireties, are mentioned:

1. U.S. Pat. No. 7,649,640 to Bryon Young et al., entitled SYSTEM AND METHOD OF PROCESSING PRINT JOBS, issued on Jan. 19, 2010, which is directed to a feature on a multifunction device that enables a user to identify different print jobs as related. A user may designate an order of output of jobs, enabling the printing of a single stack of materials that may consist of a plurality of distinct jobs. The disclosure of which is incorporated herein by reference in its entirety.

2. U.S. Pat. No. 7,872,770 to Andrew Tyrrell, entitled PRINTING SYSTEM AND METHOD FOR COMBINING MULTIPLE PRINT JOBS INTO A SINGLE COMPOUND PRINT JOB, issued on Jan. 18, 2011, which is directed to print driver functions which enable the user to collect jobs from different applications and work with them prior to sending the combined job to a multifunction device for output. The disclosure of which is incorporated herein by reference in its entirety.

### BRIEF DESCRIPTION

In some illustrative embodiments disclosed as illustrative examples herein, a method for aggregating a plurality of documents into a common document processing job at an associated multifunction device includes, with a processor, receiving a document into a job processing queue comprising a plurality of documents stored in memory of the associated multifunction device, each document including document identification data corresponding thereto, and determining a similarity between the document and at least one additional document in the job processing queue in accordance with respective document identification data associated therewith. The method also includes grouping a subset of the documents in the job processing queue into a common document processing job based at least in part on the similarity therebetween, and outputting the common job via the associated multifunction device

In some illustrative embodiments disclosed as illustrative examples herein, a system for aggregation of a plurality of documents into a common document processing job includes a processor, a job processing queue for storing documents in memory in communication with the processor, each document including corresponding document identification data, an associated user interface, and memory. The memory, which is in communication with the processor, stores instructions which are executed by the processor for receiving a document into the job processing queue and determining a similarity between the document and at least one additional document in the job processing queue in accordance with respective document identification data associated therewith. The instructions are also for grouping a subset of the documents in the job processing queue into a common document processing job based at least in part on the similarity therebetween. In addition, the instructions are for applying at least one document processing option to the common document processing job, and outputting the common job inclusive of the at least one document processing option via the associated multifunction device.

In some illustrative embodiments disclosed as illustrative examples herein, a computer-implemented method for aggregating a plurality of documents into a common document processing job includes, with a processor associated with a multifunction device, receiving a document inclusive of document identification data into a job processing queue comprising a plurality of documents stored in memory of the associated multifunction device, wherein document identification data comprises at least one of a filename, a client identification, or a submission time. The method also includes analyzing a filename so as to determine a naming convention associated therewith, and comparing each filename of documents in the job processing queue to the determined naming convention. The method further includes determining a submission time associated with each document in the job processing queue, and grouping the subset of documents in accordance with at least one of the naming convention comparison or determined submission times occurring within a preset interval. In addition, the method includes applying at least one document processing option to the common document processing job, and outputting the common job inclusive of the at least one document processing option via the associated multifunction device.

### BRIEF DESCRIPTION OF THE DRAWINGS

FIG. 1 illustrates a system capable of implementing the systems and methods for aggregating a plurality of documents into a common document processing job at an associated multifunction device in accordance with one embodiment of the subject application.

FIG. 2 illustrates an example methodology for aggregating a plurality of documents into a common document processing job at an associated multifunction device in accordance with one embodiment of the subject application.

FIG. 3 illustrates an example job processing queue capable of implementation in the systems and methods for aggregation of a plurality of documents into a common document processing job in accordance with one embodiment of the subject application.

FIG. 4 illustrates an example job processing queue containing common jobs generated in accordance with the systems and methods for aggregation of a plurality of documents into a common document processing job according to one embodiment of the subject application.

FIG. 5 illustrates a multifunction device system that is capable of implementation to facilitate aggregation of a plurality of documents into a common document processing job in accordance with one embodiment of the subject application.

FIG. 6 illustrates a system that facilitates aggregation of a plurality of documents into a common document processing job in accordance with one embodiment of the subject application.

### DETAILED DESCRIPTION

One or more implementations of the subject application will now be described with reference to the attached drawings, wherein like reference numerals are used to refer to like elements throughout.

The subject application presents methods and systems for intelligent, automatic grouping of individual print jobs into a common job at a multifunction device. When a user submits multiple documents to the multifunction device, i.e., file per page, the multifunction device stores the received jobs in a job processing queue. The jobs are then analyzed to determine the filenames, submission times, and other such data associated with each job in the queue. Those jobs that have share a common naming convention, e.g., page 1 of 4, page 2 of 4, page 1 of 3, page 3 of 3, as well as submission times that are within a predetermined interval, e.g., within 1 minute of each other, within 2 minutes of each other, etc., are then automatically grouped into a common job within the queue on the multifunction device. The user is then, upon login for release of jobs in the queue, able to view and approve such groupings. If approved, the user is provided with the ability to select document processing options, e.g., finishing options, that are applied to each document within the common job. Thus, the user need not manually sort, staple, or otherwise finish each individual job, and instead may select an option that is propagated through each document in the common job.

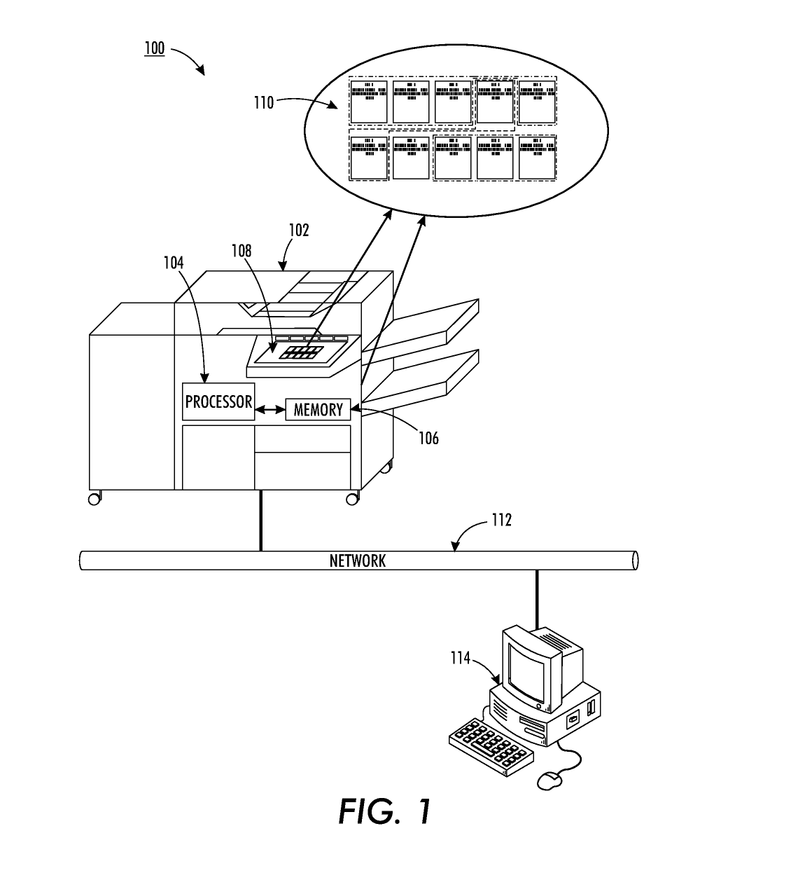

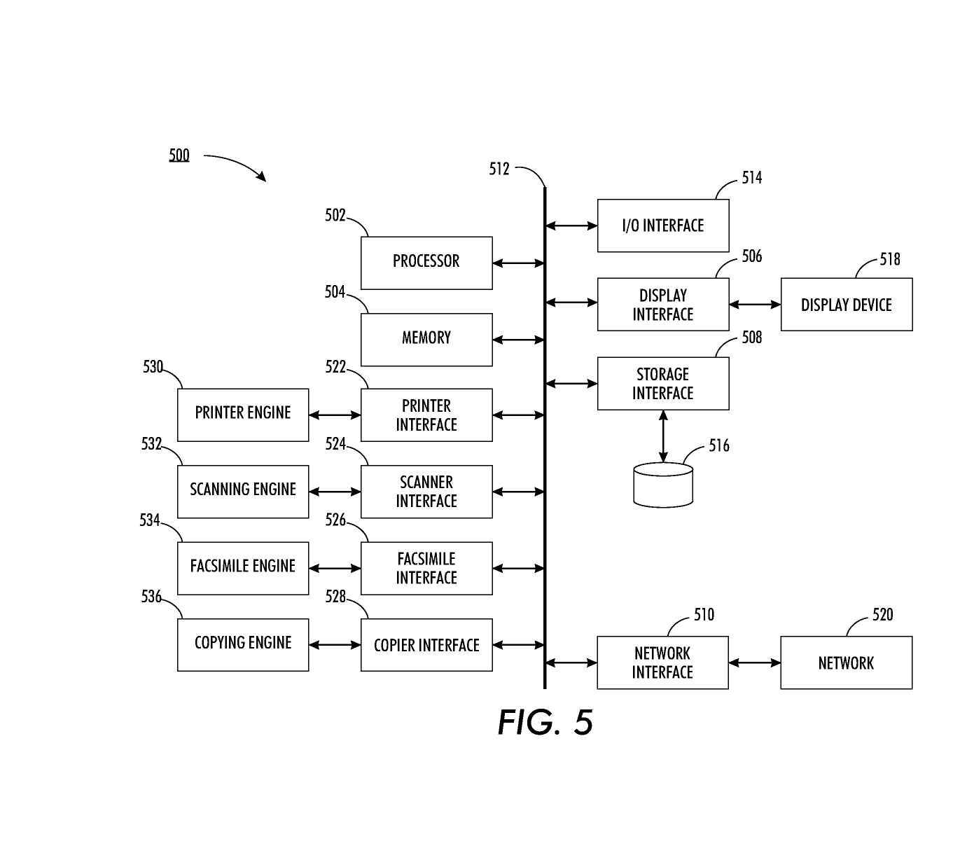

Turning now to FIG. 1, there is shown an example system 100 that may be used for aggregating a plurality of documents into a common document processing job at an associated multifunction device in accordance with the example embodiments described herein. It will be appreciated that the various components depicted in FIG. 1 are for purposes of illustrating aspects of the subject application, and that other similar components, implemented via hardware, software, or a combination thereof, are capable of being substituted therein. The system 100 includes a multifunction device 102, which is representative of any computing system, which comprises at least a processor 104 (described in greater detail as the processor 502 of FIG. 5) that executes, and a memory 106 (described in greater detail below as the memory 504 of FIG. 5) that stores computer-executable instructions for providing the various functions, calculations, selections, and the like, described herein. It will be appreciated that the multifunction device 102, is suitably adapted to perform a variety of document processing operations, including, for example and without limitation, scanning, copying, facsimile transmissions, printing, electronic mail communications, document management, document storage, or the like.

In accordance with one embodiment of the subject application, the multifunction device 102 is capable of being employed as one possible hardware configuration to support the systems and methods described herein. The skilled artisan will further appreciate that although the multifunction device 102 is illustrated as a standalone document processing device, any suitable computing environment is capable of being employed in accordance with the subject application. For example, computing architectures including, but not limited to, multiprocessor, distributed, client/server, tablet, mainframe, supercomputer, digital and analog can be employed in accordance with the one embodiment of the subject application. It will further be appreciated that the multifunction device 102 may include a computer server, workstation, personal computer, combination thereof, or any other computing device.

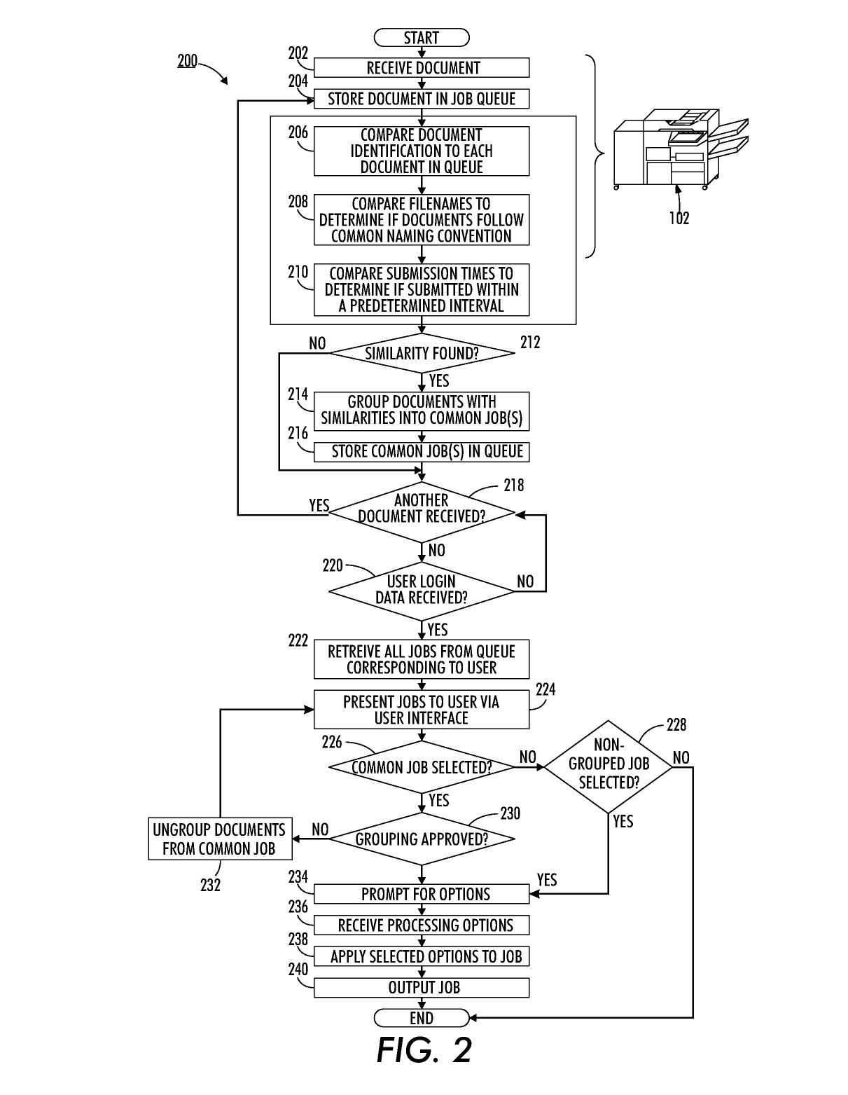

The multifunction device 102 can include a processing unit 104 (see, e.g. FIG. 5), a system memory 106 (see, e.g. FIG. 5), and a system bus (such as the bus 512 of FIG. 5) that couples various system components including the system memory 106 to the processing unit 104. The processing unit 104 can be any of various commercially available processors. The processing unit 104 can be variously embodied, such as by a single-core processor, a dual-core processor (or more generally by a multiple-core processor), a digital processor and cooperating math coprocessor, a digital controller, or the like. The processing unit 104, in addition to controlling the operation of the multifunction device 102, executes instructions stored in memory 106 for performing the methods outlined in FIGS. 2, 3, and 4, as described more fully below.

The term “software,” as used herein, is intended to encompass any collection or set of instructions executable by a computer or other digital system so as to configure the computer or other digital system to perform the task that is the intent of the software. The term “software” as used herein is also intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

The multifunction device 102 typically includes at least some form of computer readable media. Computer readable media can be any available media that can be accessed by the multifunction device 102. For example, and without limitation, computer readable media may comprise computer storage media and communication media. Computer storage media includes volatile and nonvolatile, removable and non-removable media implemented in any method or technology for storage of information such as computer readable instructions, data structures, program modules or other data.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. Communication media includes, for example, and without limitation, BLUETOOTH, WiMax, 802.11a, 802.11b, 802.11g, 802.11(x), a proprietary communications channel, infrared, optical, the public switched telephone network, or any suitable wireless data transmission system, or wired communications known in the art. Combinations of any of the above can also be included within the scope of computer readable media.

A user may enter commands and information into the computer through an input device 108 (see, e.g. FIG. 5) such as a touch-screen interface, a keyboard, a pointing device, such as a mouse, stylus, voice input, or graphical tablet. The multifunction device 102 is capable of operating in a networked environment using logical and/or physical connections to one or more remote computers, such as a remote computer(s), depicted as the network 112 of FIG. 1. The logical connections depicted include a local area network (LAN) and a wide area network (WAN). Such networking environments are commonplace in offices, enterprise-wide computer networks, intranets and the Internet. Additional functioning of the multifunction device 102 is discussed in greater detail below with respect to the example multifunction device system 500 of FIG. 5.

According to one embodiment, the memory 106 includes a job processing queue, represented by a graphical illustration of documents stored therein at 110 in FIG. 1. As depicted in FIG. 1, the queue 110 may include a plurality of documents, i.e., processing jobs, which may comprise one or more pages. In accordance with one embodiment, the queue 110 is displayed via the user interface 108, thereby enabling a user to view the contents of the queue while in physical proximity to the multifunction device 102. According to another embodiment, the job processing queue 110 is a private, or secure, job queue, such that only the user associated with the jobs submitted thereto, may access the queue 110 for output or modification in accordance with the systems and methods set forth herein. The contents of the queue 110 are illustrated and described in more detail below, with respect to FIGS. 2, 3, and 4.

As illustrated in FIG. 1, the system 100 also includes a user device 114 in data communication with the network 112. It will be appreciated that the illustration of the user device 114 as a personal computer is for example purposes only, and the subject application is capable of implementation via any suitable computing device including, for example and without limitation, a netbook computer, a laptop computer, a workstation computer, a smartphone, a personal data assistant, a web-enabled cellular telephone, a smart phone, a proprietary network device, or other web-enabled electronic device. It will be appreciated that the data communications between the multifunction device 102 and the user device 114 may be accomplished via any suitable channel of data communications via the network 112 known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications. In accordance with one embodiment of the subject application, the user device 114 is suitably configured to interact with the multifunction device 102 to facilitate document processing, send one or more documents to the device 102 for processing, and the like.

Turning now to FIG. 2, there is depicted a flowchart 200 illustrating one example embodiment of the subject application, described hereinafter using the various components of FIG. 1. It will be appreciated that the components of FIG. 1 are used hereinafter for purposes of explaining one implementation of the subject application. Various other components, as will be appreciated, are also capable of being used and implemented to perform the methods described hereinafter. Therefore, it will be appreciated that the methodology 200 of FIG. 2 may be implemented via the multifunction device 102, or other suitable processing device.

The methodology of FIG. 2 begins at 202, whereupon a document is received by the multifunction device 102 via communication from the user device 114. It will be appreciated that while referenced herein as originating from the user device 114, the subject application is capable of implementation wherein the document is received by the multifunction device 102 via network storage (not shown), operation of the multifunction device 102, or the like. According to one embodiment, the document is representative of a document processing job consisting of one page, e.g., a file per page type of job, as may occur with images, e.g., .tif, .jpeg, and the like. At 204, the received document is stored in the job processing queue 110 in memory 106. It will be appreciated that such job processing queue 110 is capable of being a secure print queue (storage), such that a specific username and/or password (i.e., login data) is required for access. In one embodiment, the received document includes data representative of a user, e.g., the associated login data, thereby restricting access to the document, or queue 110, to the user or users having knowledge of the login data.

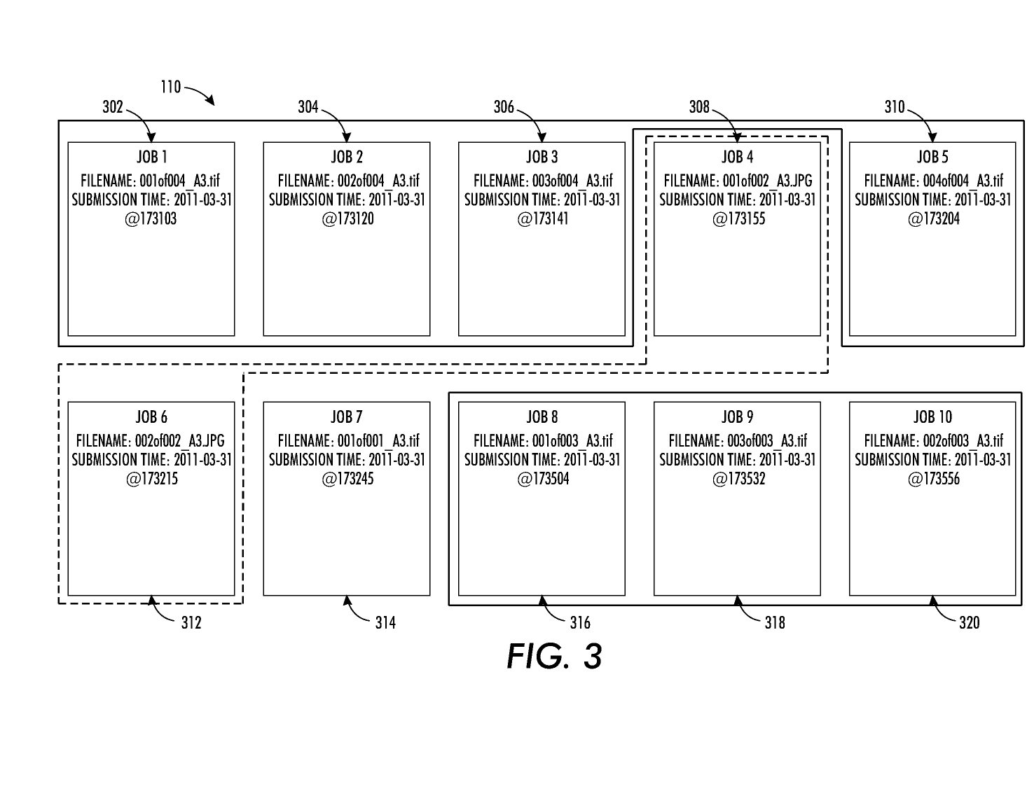

At 206, the document is compared to each document in the queue 110 via the processor 104 or other suitable components associated with the multifunction device 102. FIG. 3 illustrates an example of the job processing queue 110 in which is stored a plurality of documents 302-320, i.e., processing jobs that contain a single page. It will be appreciated that the queue 110 may include multi-page documents (jobs) as well as the file per page jobs illustrated in FIG. 3, and reference hereinafter to only file per page jobs is made solely to explain, and not limit, the subject application. For example, the documents 302-320 may include multiple pages, wherein the subject application is further capable of grouping such multi-page documents in accordance with the systems and methods set forth herein.

In one embodiment, each document, or job 302-320, includes a filename and submission time. The filenames illustrated in FIG. 3 are shown for example purposes only, and it will be appreciated that various other naming conventions, as will be appreciated may be used in accordance with embodiments of the subject application. In accordance with the comparison of 206, operations proceed to 208, whereupon the filenames of each document 302-320 are compared so as to determine if one or more documents follow or share a common naming convention. For example, a common naming convention may include, without limitation, x of y.(file extension), page x of y.(file extension), name_x.(file extension), name_y.(file extension), username_sequential number.(file extension), or any of a myriad of common used naming conventions, as will appreciated. The example implementation of FIG. 3 uses a naming convention such that the filename is ##X of##Y_.(file extension), indicating the file is page X of Y, where Y is the total number of pages of the document, i.e., a file per page type of submission. It will be appreciated that FIG. 3 illustrates that documents 302 (001of004_A3.tif), 304 (002of004A3.tif), 306 (003of004A3.tif), and 310 (004of004A3.tif) share a common naming convention (00Xof004A3.tif), whereas documents 308 (001of002A3.tif) and 312 (002of002A3.tif) share a common naming convention (00Xof002A3.tif), document 314 (001of001A3.tif) does not share a common naming convention with any of the other documents in the queue 110, and documents 316 (001of003A3.tif), 318 (003of003A3.tif), and 320 (002of003A3.tif) share a common naming convention (00Xof003A3.tif).

In continuing with the comparison initiated at 206 and 208, flow proceeds to 210, whereupon the submission times of the documents 302-320 are compared to determine with the documents were submitted within a predetermined time interval. It will be appreciated that the comparisons at 208 and 210 may be performed sequentially in any order, or simultaneously by the processor 104 or other suitable component associated with the multifunction device 102. According to one embodiment, the predetermined time interval corresponds to a period of time during which documents may have been submitted, e.g., within 30 seconds of each other, within 1 minute, within 2 minutes, within 5 minutes, within 1 hour, or the like. In accordance with another embodiment, the predetermined time interval may be calculated by the processor 104 using predefined parameters, such as, for example and without limitation, a number of documents in the queue 110, the naming convention associated with the documents in the queue 110, or the like. FIG. 3 illustrates one particular format of submission time information associated with each document 302-320 within the queue 110. For example, suitable information may include, for example and without limitation, the date, hour, minute, and seconds associated with when a document 302-320 is submitted to the queue 110.

Returning to FIG. 2, at 212, a determination is made by the processor 104 or other suitable component associated with the multifunction device 102 whether any similarities have been found in accordance with the comparisons performed via 206-210. That is, the various filenames and submission times are analyzed to determine whether any documents 302-320 share a common naming convention and/or were submitted within a predetermined time interval. As illustrated in FIG. 3, documents 302, 304, 306, and 310 share a common naming convention, as well as having each been submitted within a small time-frame of each other, e.g., shown in FIG. 3 as just over one minute of each other. Accordingly, the processor 104 would determine that the four documents 302, 304, 306, and 310 potentially represent different pages of the same document, i.e., should be grouped together. Similar determinations may be made with respect to documents 308 and 312, and 316-320.

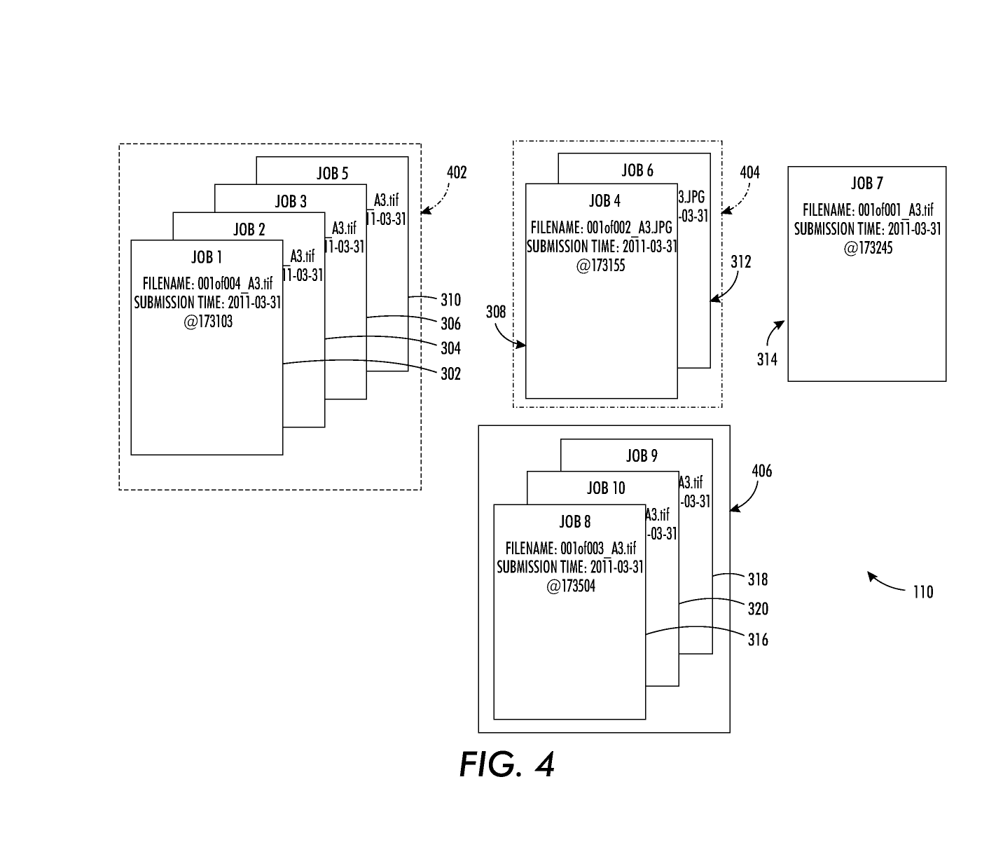

Accordingly, at 214, documents with determined similarities are grouped into common jobs within the queue 110 via the processor 104 or other suitable component associated with the multifunction device 102. For example, FIG. 4 illustrates the job queue 110 following the grouping at 214. As depicted in FIG. 4, three “common jobs” have been formed, common job 402 comprising documents 302-306 and 310, common job 404 comprising documents 308 and 312, and common job 406 comprising documents 316-320. It will be appreciated that the common jobs 402-406 may be ordered based upon the shared naming conventions during the grouping at 214. Thus, for instance, common job 406 represents documents 316-320 as ordered 316-320-318 based upon the naming convention, i.e., documents 316 (001of003A3.tif), 320 (002of003A3.tif), and then 318 (003of003A3.tif). It will be appreciated that the document 314 was determined at 212 to not have any similar documents in the queue 110 and thus remains ungrouped at 214.

At 216, the common jobs 402, 404, and 406 are stored in the job processing queue 110 as single jobs for output by the multifunction device 102. A determination is then made at 218 whether any additional documents have been received into the queue 110. Upon a positive determination at 218, operations return to 204, whereupon the newly received document is added to the job processing queue 110 and operations proceed thereafter as set forth above. Upon a negative determination at 218, i.e., no new documents have been received for processing by the multifunction device 102, flow progresses to 220, whereupon a determination is made whether user login data has been received. That is, a determination is made whether the user associated with the job processing queue 110 has logged onto the multifunction device 102 via the user interface 108 using a username, password, or other login data.

In the event that login data has not been received, operations return to 218 for a determination of whether any additional documents have been received, as discussed above. In accordance with one embodiment, the processor 104, via a suitable communication link, e.g., the network 112, communicates data indicating the groupings to the user device 114, prior to the user logging in via the user interface 108 at 220. It will be appreciated that such communication may also be sent, via the network 112, to a portable device (cell phone, smart phone, personal data assistant, etc.) associated with the user indicating the possible groupings in advance of the user logging onto the multifunction device 102. Other variations of notifying the user with respect to the groupings are also contemplated in accordance with the subject application, and the description herein, as will be appreciated, is equally applicable thereto. In such an embodiment, the approval and option selection, discussed below, may be communicated in a responsive communications to the multifunction device 102.

Upon a determination that login data has been received, operations proceed to 222, whereupon all jobs corresponding to the user login data (402, 404, 406, and document 314) are retrieved from the job processing queue 110. The jobs 402, 404, 406, and 314 are then presented to the associated user via the user interface 108 or other suitable presentation means (display, portable electronic device, etc.) with which the user has access. In accordance with one embodiment of the subject application, a graphical representation of the job queue 110 is generated via the user interface 108, such as the groupings of FIG. 4, for selection thereof by the user for release to output by the multifunction device 102.

At 226, a determination is made whether one of the common jobs 402, 404, or 406 has been selected by the user via the user interface 108. Upon a determination at 226 that the user has not selected one of the common jobs 402, 404, or 406, operations proceed to 228, whereupon a determination is made whether the user has selected a non-grouped job, i.e., document 314. In the event that no job has been selected, operations with respect to FIG. 2 terminate. Upon a determination at 228 that a non-grouped job has been selected, operations proceed to 234, whereupon the user is prompted, via the user interface 108, for document processing options associated with the document 314. That is, the user is presented with the opportunity to apply finishing options to the document 312 prior to output, e.g., stapling, duplex, hole-punch, sorting, color adjustments, sizing adjustments, other finishing options, or the like. Any selected processing options are then received at 236 via user interaction with the user interface 108 or other suitable component associated with the multifunction device 102. The selected options are then applied to the job, e.g., document 314, at 238, following which the document 314 is output by the multifunction device 102 at 240 in accordance with the selected options.

Returning to 226, upon a determination that the job selected by the user is one of the common jobs 402, 404, or 406, operations proceed to 230. At 230, the user is presented with the ability to approve the grouping of the jobs together, or to ungroup the documents 302-312 and 316-318 from the common jobs 402, 404, or 406. In the event that the user does not approve of the grouping of documents 302-312 and 316-318 into the common jobs 402, 404, or 406, the selected common job 402, 404, or 406 is ungrouped at 232, and operations return to 224, whereupon a revised job processing queue 110 is presented to the user. For example, when the user has selected the common job 404 at 226, but does not approve of the grouping, the common job 404 is ungrouped at 232, and the documents 308 and 312 are presented to the user as individual jobs in the job processing queue 110 at 224.

When the user has approved the grouping of the selected common job 402, 404, or 406, operations proceed to 234, whereupon the user is prompted for the selection of document processing options to be associated with the selected common job 402, 404, or 406. The selected options are received at 238 and applied to the selected common job 402, 404, or 406 at 238. That is, the processor 104 or other suitable component associated with the multifunction device 102 treats each document 302-312 or 316-320 as a part of the selected common job 402, 404, or 406, such that they are treated as pages of a single job. Accordingly, the selected options, e.g., duplex, stapling, sorting, hole-punch, or the like, are applied to each document 302-312 or 316-320 in the selected common job 402, 404, or 406. Thereafter, the selected common job 402, 404, or 406 is output by the multifunction device 102 at 240.

Turning now to FIG. 5, illustrated is a representative multifunction device 500 (depicted in FIG. 1 as the multifunction device 102) that facilitates aggregation of a plurality of documents into a common document processing job in connection with one embodiment of the subject application. The multifunction device 500 includes a processor unit 502 which is advantageously placed in data communication with memory 504, which may include, for example and without limitation, non-volatile read only memory, volatile read only memory, random access memory or a combination thereof, a display interface 506, a storage interface 508, and a network interface 510. In one embodiment, interfacing with the foregoing modules is suitably accomplished via a bus 512. The processor 502 executes, and the memory 504 stores computer-executable instructions for performing the various functions, methods, steps, techniques, and the like, described herein. The processor 502 and memory 504 may be integral to each other or remote but operably coupled to each other.

The memory 504 suitably includes firmware, such as static data or fixed instructions, such as BIOS, system functions, configuration data, and other routines used for operation of the computer system 500 via the processor 502. The memory 504 is further capable of providing a storage area for data and instructions associated with applications and data handling accomplished by the processor 502.

The display interface 506 receives data or instructions from other components on the bus 512, which data is specific to generating a display to facilitate a user interface. The display interface 506 suitably provides output to a display device 518, suitably a video display such as a monitor, LCD, plasma, or any other suitable visual output device as will be appreciated by one of ordinary skill in the art.

As will be appreciated by those skilled in the art, the storage interface 508 is configured to provide a mechanism for non-volatile, bulk or long term storage of data or instructions in the computer system 500. The storage interface 508 suitably uses a storage mechanism, such as storage 516, suitably comprised of a disk, tape, CD, DVD, or other relatively higher capacity addressable or serial storage medium.

The network interface 510 suitably comprises a network interface card, a wireless network interface, or the like. It will be appreciated that by one of ordinary skill in the art that a suitable network interface is comprised of both physical and protocol layers and is suitably any wired system, such as Ethernet, token ring, or any other wide area or local area network communication system, or wireless system, such as Wi-Fi, WiMax, or any other suitable wireless network system, as will be appreciated by one of ordinary skill in the art. In the illustration of FIG. 5, the network interface 510 is connected to a physical network 520, suitably comprised of a local area network, wide area network, or a combination thereof.

An input/output interface 514 in data communication with the bus 512 is suitably connected with input devices, such as a keyboard, mouse, pointing device, touch screen inputs, or the like. In addition, the input/output interface 514 is further capable of data input and output to or from a peripheral interface, such as a USB, universal serial bus output, SCSI, IEEE 1394 output, or any other interface as may be appropriate for a selected application.

Also in data communication with the bus 512 are interfaces to one or more document processing engines. As illustrated in FIG. 5, the multifunction device 500 includes a printer interface 522, a scanner interface 524, a copier interface 526, and a facsimile interface 528. According to one embodiment of the subject application, the preceding interfaces 522-528 facilitate respective communication with a printer engine 530, a scanning engine 532, a copier engine 534, and a facsimile engine 536. It is to be appreciated that the multifunction device 500 suitably accomplishes one or more document processing functions.

It will be appreciated that the print engine 522 suitably enables the output of physical documents representing an electronic document communicated to the multifunction device 500. It will also be appreciated that the scanning engine 532 is suitably adapted to receive hard copy documents and generate electronic image data therefrom. According to certain embodiments of the subject application, the scanning engine 532 is capable of generating such image data from tangible documents in a variety of forms, including, for example and without limitation, bitmapped data, vector data, page description language formatted data, and the like. It will further be appreciated that optical character recognition is also capable of being performed via functioning of the scanning engine 532. The copier engine 534 is suitably adapted to operate in conjunction with the scanning engine 532 and the printer engine 530 so as to generate tangible copies of input documents, as will be appreciated by those skilled in the art. In accordance with one embodiment, the facsimile engine 536 communicates to or from external facsimile devices (not shown).

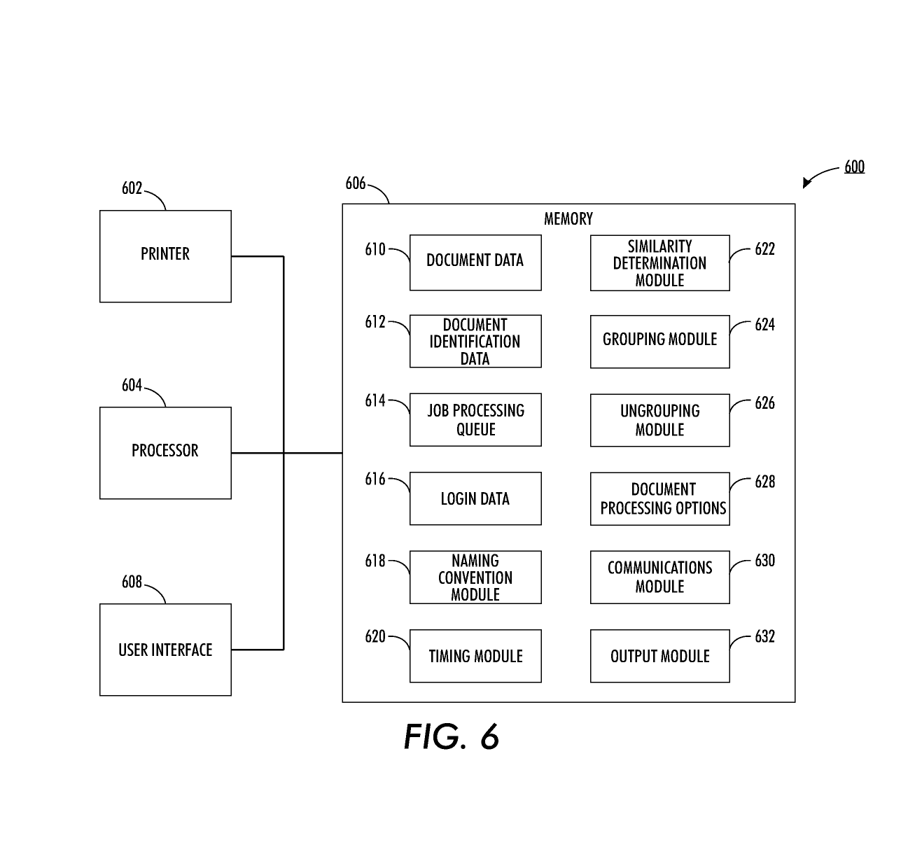

FIG. 6 illustrates a system 600 that facilitates aggregating a plurality of documents into a common document processing job in accordance with one embodiment of the subject application. The system comprises a print engine 602 that is coupled to a processor 604 that executes, and a memory 606 that stores computer-executable instructions for performing the various functions, methods, techniques, steps, and the like described herein. The processor 604 and memory 606 may be integral to each other or remote but operably coupled to each other. In another embodiment, the processor 604 and memory 606 are integral to the printer 602. In another embodiment, the processor 604 and memory 606 reside in a single computing device that is operably coupled to the printer 602.

According to one embodiment of the subject application, the system 600 comprises the processor 604 that executes, and the memory 606 that stores one or more computer-executable modules (e.g. programs, computer-executable instructions, etc.) for performing the various functions, methods, procedures, etc., described herein. Additionally, “module,” as used herein, denotes application specific hardware, a set of computer-executable instructions, software code, program, routine, or other computer-executable means for performing the described function, or a suitable combination thereof, as will be understood by those of skill in the art. Furthermore, or alternatively, one or more of the functions described hereinafter with respect to the modules may be manually performed.

The memory 606 may be a computer-readable medium on which a control program is stored, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, RAM, ROM, PROM, EPROM, FLASH-EPROM, variants thereof, other memory chip or cartridge, or any other tangible medium from which the processor can read and execute. In this context, the systems described herein may be implemented on or as one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like.

Upon receipt of document data 610, which includes document identification data 612, the processor 604 adds the document corresponding thereto to the job processing queue 614. In addition, the received document may also include login data 616 corresponding to an identification of a user associated with the received document. According to one embodiment, the job processing queue 614 resident in the memory 606, stores a plurality of documents, each of which includes corresponding document data 610 and document identification data 612. In accordance with such an embodiment, the document identification data 612 may include, for example and without limitation, a filename, a submission time, user identification information, and the like. It will be appreciated that the job processing queue 614 may be a secure queue, which is restricted to access only by the user or users associated with the user identification information.

The processor 604 may then initiate a naming convention module 618, which is configured to analyze document identification data 612 corresponding to the filename of each document in the job processing queue 614. According to one embodiment, the naming convention module 618 may store varying naming rules and common naming conventions. The naming convention module, via the processor 604, identifies common naming conventions, i.e., shared naming conventions, amongst those documents in the job processing queue 614. The naming conventions thus identified are communicated from the naming convention module 618 to the similarity determination module 622, as discussed in greater detail below.

The processor 604 further initiates a timing module 620 that is configured to identify documents in the job processing queue 614 that were submitted within a pre-selected time interval. According to one embodiment, the timing module 620 includes predetermined intervals during which documents submitted may be related. For example, the predetermined intervals may be set for seconds, minutes, hours, days, etc. An output of the timing module 620 to the similarity determination module 622 may include, for example and without limitation, identification of groups of two or more documents in the job processing queue 614 that have submittal times within the predetermined timing interval.

The similarity determination module 622, operative in conjunction with the processor 604, receives the output identifications from the naming convention module 618 and the timing module 620 corresponding to documents in the job processing queue 614. The similarity determination module 622 then facilitates, via operations of the processor 604, determining whether subsets of documents in the job processing queue 614 are related, and thus should be grouped. That is, the similarity determination module 622 analyzes the output from the naming convention module 618 to identify whether a similarity exists among any of the documents in the job processing queue 614 based upon identified common naming conventions. A similar operation is performed on the documents in the job processing queue 614 by the similarity determination module 622 with respect to the identified submission intervals provided by the timing module 620. It will be appreciated that other components or modules may be used in accordance with the received document identification data in addition to or replacement of the naming convention module 618 and the timing module 620.

The various documents identified by the similarity determination module 622 as being similar are grouped via operations of the grouping module 624 into one or more common jobs. That is, the grouping module 624, based upon the similarities among documents determined by the determination module 622, groups a subset or subsets of the documents in the job processing queue 614 into one or more common jobs. It will be appreciated that such groupings may be ordered by the grouping module 624 in accordance with the submission times or names of the documents within the group, e.g., chronological ordering, alphabetical ordering, numerical ordering, or a combination thereof.

Upon receipt of login data 616 via the user interface 608, all jobs (documents) stored in the job processing queue 614 associated with the login data 616 are retrieved by the processor 604 and displayed to the user via the user interface 608. It will be appreciated that the illustrations of the various jobs in FIG. 4 are for example purposes, and other graphical or non-graphical depictions of the grouped and/or ordered jobs are also capable of being displayed to the user via the user interface 608. Upon selection of one of the common jobs stored in the job processing queue 614, the processor, via the user interface 608, the user is prompted to approve or disapprove the groupings made by the grouping module 624. That is, the various common jobs are presented to the user via the user interface 608 so as to allow the user to maintain the grouped documents in the common job, or to ungroup the documents for individual processing. According to one embodiment, upon a selection of a common job to ungroup, an ungrouping module 626 is initiated by the processor 604, so as to release all documents in the common job back into individual jobs in the job processing queue 614.

After receiving approval for the grouping via the user interface 608, the processor 604, in conjunction with the user interface 608, presents available document processing options 628 for application to the selected job. It will be appreciated that the document processing options 628 are representative of finishing options, color corrections, correlation, number of copies, saturation adjustments, and the like, associated with output by the system 600 of the selected common job. According to one embodiment, the finishing options may include, for example and without limitation, hole punching, stapling, duplex printing, image rotation, binding, ordering, and the like.

Following receipt of selected document processing options 628, the processor 604 facilitates propagation of the selection options 628 to the common job, i.e., to each document in the common job. Thus, it will be appreciated, the user need only select, for example hole punch, one time for all documents in the common job to be hole punched, or duplexed. The output module 632 then facilitates output of the common job with selected options to the printer 602 for completion. In accordance with one embodiment, the system 600 includes a communications module 630 that facilitates communication of the groupings to a selected external device (not shown) for approval or disapproval by the user prior to user interaction with the user interface 608. That is, an electronic communication, such as SMS, text, electronic mail, or the like, is sent via the communications module to a portable electronic device associated with the user, to the user device 114, or the like, indicating the proposed groupings. In such an embodiment, the communications module 630 is operative to receive approval/disapproval of the proposed groupings via return communication from such external device.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for aggregating a plurality of documents into a common document processing job at an associated multifunction device, comprising:
with a processor, receiving a document into a job processing queue comprising a plurality of documents stored in memory of the associated multifunction device, each document comprising document identification data corresponding thereto;
determining a similarity between the document and at least one additional document in the job processing queue in accordance with respective document identification data associated therewith;
grouping a subset of the documents in the job processing queue into a common document processing job based at least in part on the similarity therebetween; and
outputting the common job via the associated multifunction device.

2. The method of claim 1, wherein the document identification data includes at least one of a filename, a client identification, and a submission time.

3. The method of claim 2, wherein the determining a similarity further comprises:
analyzing a filename so as to determine a naming convention associated therewith;
comparing each filename of documents in the job processing queue to the determined naming convention; and
grouping the subset of the documents in accordance with a result of the filename and naming convention comparison.

4. The method of claim 3, further comprising:
determining a submission time associated with each document in the job processing queue; and
grouping the subset of documents in accordance with the determined submission times occurring within a preset interval.

5. The method of claim 3, further comprising ordering each document in the subset of documents in accordance with the filenames corresponding thereto.

6. The method of claim 1, further comprising:
applying at least one document processing option to the common document processing job; and
outputting the common job inclusive of the at least one document processing option via the associated multifunction device.

7. The method of claim 6, wherein the at least one document processing option is a staple, a binding, a duplex operation, a hole punch, or a page orientation.

8. The method of claim 1, wherein the document is a TIFF image, a JPEG image, a word processing document, an image document, or a PDF document.

9. The method of claim 6, further comprising:
receiving login data from an associated user corresponding to an identification thereof;
retrieving the job processing queue from memory in accordance with received login data;
receiving user approval data representative of an approval of the grouping of the subset of documents into the common document processing job; and
receiving selection data representative of the at least one document processing option via a user interface associated with the multifunction device.

10. The method of claim 6, further comprising:
receiving login data from an associated user corresponding to an identification thereof;
retrieving the job processing queue from memory in accordance with received login data;
receiving user data representative of a disapproval of the grouping of the subset of documents into the common document processing job; and
ungrouping the common document processing job into its component documents in the job processing queue.

11. A system for aggregating a plurality of documents into a common document processing job comprising memory which stores instructions for performing the method of claim 1 and a processor in communication with the memory for executing the instructions.

12. A computer program product comprising a non-transitory recording medium storing instructions, which when executed by a computer causes the computer to perform the method of claim 1.

13. A system for aggregation of a plurality of documents into a common document processing job, comprising:
a processor;
a job processing queue for storing a plurality of documents in memory in communication with the processor, each document comprising document identification data corresponding thereto; and
an associated user interface;
wherein the memory in communication with the processor stores instructions which are executed by the processor for:
receiving a document into the job processing queue;
determining a similarity between the document and at least one additional document in the job processing queue in accordance with respective document identification data associated therewith;
grouping a subset of the documents in the job processing queue into a common document processing job based at least in part on the similarity therebetween;
applying at least one document processing option to the common document processing job; and
outputting the common job inclusive of the at least one document processing option via the associated multifunction device.

14. The system of claim 13, wherein the memory further stores instructions for:
analyzing a filename corresponding to at least one document in the job processing queue so as to determine a naming convention associated therewith;
comparing each filename of documents in the job processing queue to the determined naming convention; and
grouping the subset of the documents in accordance with a result of the filename and naming convention comparison.

15. The system of claim 14, wherein the memory further stores instructions for ordering each document in the subset of documents in accordance with the filenames corresponding thereto.

16. The system of claim 13, wherein the memory further stores instructions for:
determining a submission time associated with each document in the job processing queue; and
grouping the subset of documents in accordance with the determined submission times occurring within a preset interval.

17. The system of claim 13, wherein the memory further stores instructions for:
Receiving, via the associated user interface, login data from an associated user corresponding to an identification thereof;
retrieving the job processing queue from memory in accordance with received login data;
receiving user data representative of an approval or disapproval of the grouping of the subset of documents into the common document processing job; and
ungrouping the common document processing job into its component documents in the job processing queue in accordance with received user data representative of a disapproval of the grouping; and
receiving selection data representative of the at least one document processing option via a user interface associated with the multifunction device in accordance with received user data representative of an approval of the grouping.

18. The system of claim 13, wherein the at least one document processing option is a staple, a binding, a duplex operation, a hole punch, or a page orientation.

19. A computer-implemented method for aggregating a plurality of documents into a common document processing job, comprising:
with a processor associated with a multifunction device, receiving a document inclusive of document identification data into a job processing queue comprising a plurality of documents stored in memory of the associated multifunction device, wherein document identification data comprises at least one of a filename, a client identification, or a submission time;
analyzing a filename so as to determine a naming convention associated therewith;
comparing each filename of documents in the job processing queue to the determined naming convention;
determining a submission time associated with each document in the job processing queue;
grouping the subset of documents in accordance with at least one of the naming convention comparison or determined submission times occurring within a preset interval;
applying at least one document processing option to the common document processing job; and
outputting the common job inclusive of the at least one document processing option via the associated multifunction device.

20. The computer-implemented method of claim 19, further comprising:
receiving login data from an associated user corresponding to an identification thereof;
retrieving the job processing queue from memory in accordance with received login data;
receiving user data representative of an approval or disapproval of the grouping of the subset of documents into the common document processing job; and
ungrouping the common document processing job into its component documents in the job processing queue in accordance with received user data representative of a disapproval of the grouping; and
receiving selection data representative of the at least one document processing option via a user interface associated with the multifunction device in accordance with received user data representative of an approval of the grouping.
